(19) United States
(12) Patent Application Publication
(10) Pub. No.: US 2025/0151706 A1
(43) Pub. Date: May 15, 2025

(54) ULTRAVIOLET LEDS-BASED FLUORESCENT FISHING LURE CHARGING DEVICE

(71) Applicant: Daniel Roehl, Lynnwood, WA (US)

(72) Inventor: Daniel Roehl, Lynnwood, WA (US)

(21) Appl. No.: 18/910,376

(22) Filed: Oct. 9, 2024

Related U.S. Application Data
(60) Provisional application No. 63/598,710, filed on Nov. 14, 2023.

(51) Int. Cl. A01K 85/01; H02J 7/00

(52) U.S. Cl. CPC A01K 85/015; H02J 7/00

(57) ABSTRACT

An ultraviolet fluorescent fishing lure charging tube device is disclosed. The device comprises a hollow cylindrical main body with an interior surface lined with waterproof UV LEDs to charge the lures effectively. The device includes a power wire for supplying electrical power to the LEDs and features a mounting assembly with a free-mounting unit and ball mount for flexible positioning on marine vessels. Additionally, the device can be equipped with an aluminum flange for secure mounting. The invention also includes an automatic intensity adjustment feature to prevent overcharging and conserve power. The method of use involves positioning the device, powering the LEDs, and placing the lure inside the tube for charging, enabling the lure to glow thereafter in low-light conditions.

### CROSS-REFERENCE TO RELATED APPLICATION

The present application claims priority to, and the benefit of, U.S. Provisional Application No. 63/598,710, which was filed on Nov. 14, 2023, and is incorporated herein by reference in its entirety.

### FIELD OF THE INVENTION

The present invention generally relates to the field of fishing equipment, particularly those used to enhance the visibility of fluorescent lures. More specifically, the present invention pertains to an ultraviolet fluorescent fishing lure charging tube device designed to uniformly charge lures using UV-LED lights. The device features a hollow cylindrical body lined with waterproof UV LEDs that emit light in the UV-A wavelength range to charge the lure effectively. The device includes versatile mounting options for secure attachment to marine vessels and is built to withstand harsh marine environments. This invention improves fishing efficiency by ensuring lures are fully charged and glowing, making them more attractive to fish in low-light conditions. Accordingly, the present disclosure makes specific reference thereto. Nonetheless, it is to be appreciated that aspects of the present invention are also equally applicable to other like applications, devices, and methods of manufacture. For example, the present invention can be used on items or devices needing a 360 degree UV-LED light for charging a 3D object in all directions.

### BACKGROUND

By way of background, fluorescent fishing lures are widely used by anglers, particularly in low-light conditions, as they provide enhanced visibility and attract fish more effectively. Traditionally, fishing lures are charged using handheld flashlights or camera flash bulbs. However, such conventional methods have significant limitations that hinder their effectiveness and convenience.

One of the primary drawbacks of using a flashlight or flash bulb is that they only illuminate a limited area of the lure, typically just one side, which results in uneven charging. This partial charging reduces the lure's overall glow, making it less effective in attracting fish. Additionally, the process of charging a lure with a flashlight is time-consuming, requiring a prolonged exposure to achieve sufficient brightness. During this time, the angler must hold onto the lure, increasing the risk of injury from the lure's hooks. Moreover, traditional methods often rely on separate power sources, such as batteries, which adds to the bulk and inconvenience of the equipment. Loose items like flashlights and camera flashes are prone to being misplaced or lost, especially in the challenging conditions of marine environments. The effects of saltwater exposure further accelerate the degradation of these devices, leading to frequent replacements and additional costs. Individuals desire a more efficient, comprehensive, and user-friendly solution for charging fluorescent fishing lures.

Therefore, there exists a long-felt need in the art for a more efficient and reliable method to charge fluorescent fishing lures. There is also a long-felt need in the art for a reliable device that can provide even illumination of fishing lures. Additionally, there is a long-felt need in the art for a portable, durable device that can uniformly charge the entire surface of a lure quickly and without the need for multiple, easily misplaced tools such as flashlights or extra batteries. Moreover, there is a need for a solution that can withstand the harsh conditions of marine environments. Furthermore, there is a long-felt need in the art for a device that creates a highly visible lure in water, especially in low-light conditions and murky or stained water. Finally, there is a long felt need in the art for a device that helps in providing enhanced visibility of fishing lures that helps fish locate the bait more easily such as dawn, dusk, or overcast days when fish may be more active and feeding.

The subject matter disclosed and claimed herein, in one embodiment thereof, comprises an ultraviolet fluorescent fishing lure charging tube device designed to uniformly charge fluorescent fishing lures using UV-LED lights. The device includes a hollow cylindrical main body with an interior surface lined with waterproof UV LEDs. The device further includes a power wire routed through the rear end of the tube, supplying the necessary electrical power to the LEDs. The invention also features a mounting assembly with a threaded hole for accommodating a ball mount, enabling the device to be flexibly positioned on a marine vessel. Additionally, the device can be equipped with an aluminum flange for secure mounting.

In this manner, the ultraviolet fluorescent fishing lure charging tube device of the present invention accomplishes all of the foregoing objectives and provides a novel, reliable, efficient, and user-friendly solution for charging fluorescent lures. The device ensures that the entire lure is evenly charged, maximizing its glow and effectiveness in attracting fish during low-light conditions. The device includes integrated UV-LED lights which offer quick and safe charging. The invention not only enhances the safety and convenience for anglers by reducing the need to handle the lure during charging, but also improves the overall efficiency of night and deep-sea fishing. The device is designed to withstand the corrosive effects of saltwater, ensuring long-term durability and consistent performance across various fishing settings.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ultraviolet fluorescent fishing lure charging tube device. The device comprises a hollow main body which has an interior surface and extends from a front end to a rear end, the hollow main body defines a hollow cavity for receiving a fluorescent fishing lure. A plurality of waterproof UV LED lights are disposed on the interior surface of the hollow main body, wherein the UV LED lights emit ultraviolet light in the UV-A wavelength range to charge the fluorescent fishing lure placed within the hollow cavity. A power wire is routed through the rear end of the hollow main body, the power wire is configured to supply electrical power to the UV LED lights. A mounting assembly comprising a free-mounting unit with a threaded hole is configured to accommodate a ball mount for flexible positioning of the device on a marine vessel.

In yet another embodiment, a method for charging a fluorescent fishing lure using an ultraviolet fluorescent fishing lure charging tube device is disclosed. The method includes positioning the charging tube device at a selected location on a marine vessel, supplying electrical power to a plurality of waterproof UV LED lights disposed within the charging tube device via a power wire, placing a fluorescent fishing lure within a hollow cavity of the charging tube device, emitting ultraviolet light from the UV LED lights in the UV-A wavelength range to charge the fluorescent fishing lure, and enabling the fluorescent fishing lure to absorb the ultraviolet light for a predetermined period to enable the lure to glow in the dark.

In another aspect, an ultraviolet fluorescent fishing lure charging tube device is described. The device includes a hollow cylindrical main body with a front end, a rear end, and an interior surface forming a hollow cavity for receiving a fluorescent fishing lure, a plurality of UV LED lights arranged in a sheet light or ribbon configuration on the interior surface, the UV LED lights emitting light in the UV-A wavelength range around 320 nm to about 410 nm to charge the fluorescent fishing lure, a removable protective cap attached to the rear end of the hollow cylindrical main body, the protective cap configured to prevent water ingress into the hollow cavity, and an aluminum flange is attached to the front end of the hollow cylindrical main body, the aluminum flange is configured to enable the device to be securely mounted by sliding into a hole on a marine vessel.

In still another aspect, the UV LED lights are configured to automatically adjust the intensity of the ultraviolet light based on the charging level of the fluorescent fishing lure to prevent overcharging and conserve electrical power.

In another embodiment, the free-mounting unit is attached to a surface of the marine vessel using stainless steel screws and marine adhesive, and wherein the ball mount is a 1.5-inch ball mount adapted for use with various clamping methods in the marine industry.

In still another embodiment, the device includes a logo or indicia disposed on the outer surface of the hollow cylindrical main body for branding and marketing purposes.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a portable ultraviolet fluorescent fishing lure charging tube device of the present invention in accordance with the disclosed structure;

FIG. 2 illustrates a perspective view of another embodiment of the portable ultraviolet fluorescent fishing lure charging tube device of the present invention in accordance with the disclosed structure;

FIG. 3 illustrates a perspective view showing use of the ultraviolet led-based portable fluorescent fishing lure charging device of the present invention for charging fishing lures in accordance with the disclosed structure; and

FIG. 4 illustrates a flow chart depicting a process of use of the charging fishing lures using the charging device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a more efficient and reliable method to charge fluorescent fishing lures. There is also a long-felt need in the art for a reliable device that can provide even and overall illumination of fishing lures and other 3D objects. Additionally, there is a long-felt need in the art for a portable, durable device that can uniformly charge the entire 3D surface area of a lure quickly and without the need for multiple, easily misplaced tools such as flashlights or extra batteries. Moreover, there is a need for a solution that can withstand the harsh conditions of marine environments. Furthermore, there is a long-felt need in the art for a device that creates a highly visible lure in water, especially in low-light conditions and murky or stained water. Finally, there is a long felt need in the art for a device that helps in providing enhanced visibility of fishing lures that helps fish locate the bait more easily such as dawn, dusk, or overcast days when fish may be more active and feeding.

The present invention, in one exemplary embodiment, is an ultraviolet fluorescent fishing lure charging tube device. The device comprises a hollow main body which has an interior surface and extends from a front end to a rear end, the hollow main body defines a hollow cavity for receiving a fluorescent fishing lure or other 3D object. A plurality of waterproof UV LED lights are disposed on the interior surface of the hollow main body, wherein the UV LED lights emit ultraviolet light in the UV-A wavelength range to charge the fluorescent fishing lure placed within the hollow cavity. A power wire is routed through the rear end of the hollow main body, the power wire is configured to supply electrical power to the UV LED lights. A mounting assembly comprising a free-mounting unit with a threaded hole is configured to accommodate a ball mount for flexible and pivotable positioning of the device on a marine vessel.

Reference will now be made in detail to the present preferred embodiments of the invention, examples of which are illustrated in the accompanying drawings. Wherever possible, the same reference numerals are used in the drawings and the description to refer to the same or like parts.

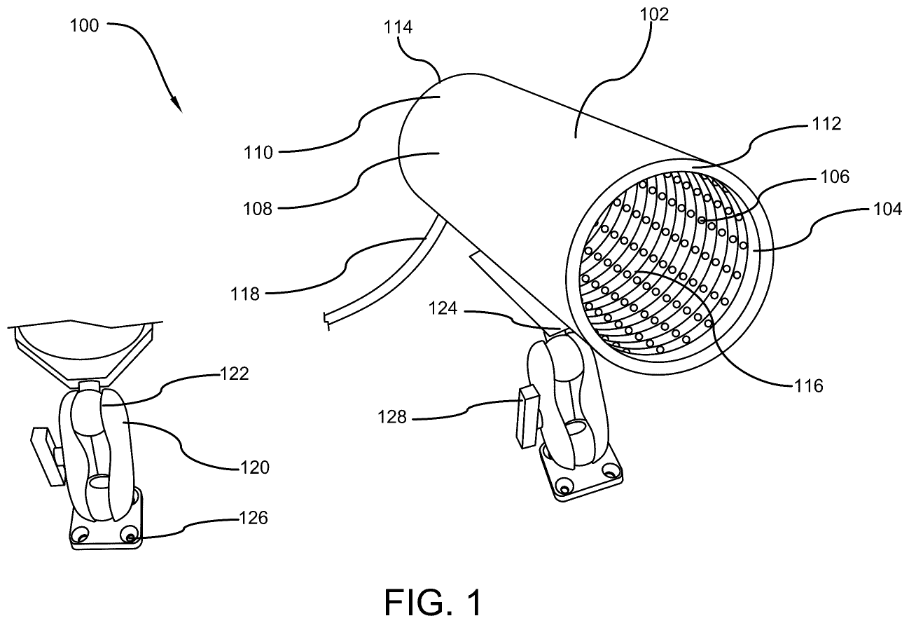

Referring initially to the drawings, FIG. 1 illustrates a perspective view of portable ultraviolet fluorescent fishing lure charging tube device of the present invention in accordance with the disclosed structure. The ultraviolet fluorescent fishing lure charging tube device 100 of the present invention is designed as a portable device to enhance the visibility of fluorescent fishing lures by using ultraviolet (UV) light. More specifically, in the present embodiment, the ultraviolet fluorescent fishing lure charging tube device 100 includes a hollow cylindrical main body 102 which is preferably cylindrical but can be of any geometric shape. The interior surface 104 of the main body 102 is lined with waterproof UV LED lights 106 and the lights 106 can be arranged in different configurations such as sheet light configuration or a ribbon style configuration. In the preferred embodiment, UV LEDs 106 used in the device 100 operate in the UV-A wavelength range, from about 320 nm to about 410 nm and are effective for charging glow-in-the-dark materials without causing harm to human skin. The UV LEDs 106 have a high radiant flux and emit a concentrated beam of UV light that can quickly charge fluorescent fishing lures or other 3D objects. In radiometry, radiant flux or radiant power is the radiant energy emitted, reflected, transmitted, or received per unit time, and spectral flux or spectral power is the radiant flux per unit frequency or wavelength, depending on whether the spectrum is taken as a function of frequency or of wavelength. The SI unit of radiant flux is the watt (W), one joule per second (J/s), while that of spectral flux in frequency is the watt per hertz (W/Hz) and that of spectral flux in wavelength is the watt per meter (W/m)—commonly the watt per nanometer (W/nm). Further, UV LEDs 106 are waterproof and have a waterproof rating of IP65 or higher. A logo or indicia 108 can be disposed on the outer surface 110 of the main body 102 for branding and marketing purposes.

The main body 102 extends from a front or first end 112 thereof to a rear or second end 114. The front or first end 112 is open and enables access of the hollow cavity 116 formed by the cylindrical hollow main body 102. The hollow cavity 116 provides space for placement of a fluorescent fishing lure 302 for charging using the UV LEDs 106. The UV LEDs 106 emit UV lights for providing adequate illumination of the fluorescent fishing lure 302. A power wire 118 is routed through the rear or second end 114 of the main body tube 102. The power wire 118 is adapted to supply electrical power to the UV LED lights 106, enabling the LEDs 106 to emit UV light and charge the lures placed in the hollow cavity 116. The rear or second end 114 may include a protective cap which can be removed when required and is adapted to prevent water from ingress into the main body tube 102. In one embodiment, intensity of the UV lights can be adjusted automatically based on the charging level of the fishing lure for preventing overcharging and conserving electrical power.

The present embodiment of the device 100 includes a free-mounting unit 120 which has a threaded hole 122. The threaded hole 122 is adapted to accommodate a 1.5-inch ball mount 124. The mount 124 can be used in conjunction with various clamping methods commonly used in the marine industry, enabling for flexible positioning, pivotal movement, and adjustable mounting configurations. Preferably, the free-mounting unit 120 is attached to a surface using four stainless steel screws 126. A clamp 128 can be used for clamping and adjusting the mounting unit 120.

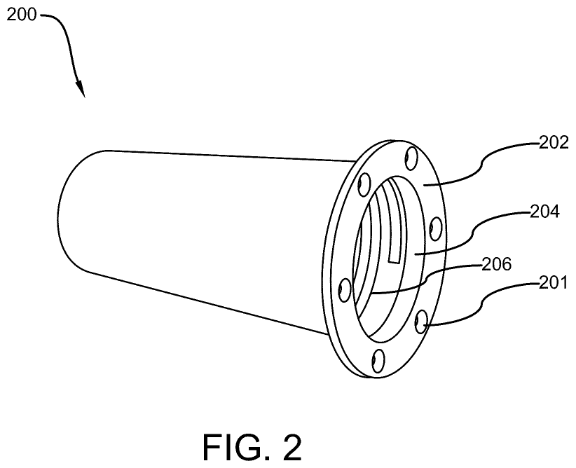

FIG. 2 illustrates another perspective view of the portable ultraviolet fluorescent fishing lure charging tube device of the present invention in accordance with the disclosed structure. In the present embodiment, the charging tube device 200 includes an aluminum flange 202 which is removably attached to the open end 204 of the tube device 200 using mechanical screws 201. The flange 202 enables the tube device 200 to be mounted securely on a boat gunwale by sliding or inserting the device 200 into a 3.5-inch to 4.5-inch hole or another gunwale rod holder opening, and securing the flange 202 to the gunwale. Further, the flange 202 provides stability and ensures that the tube stays in place during use. The device 200 has the same functionality and operation as of the device 100 of FIG. 1 and includes UV LEDs 206 for charging fluorescent fishing lures. Depending on the user's preference and the setup of their fishing vessel, the tube device can be mounted using the flange 202 or the ball mount 124, providing different options of how the device 100 can be used.

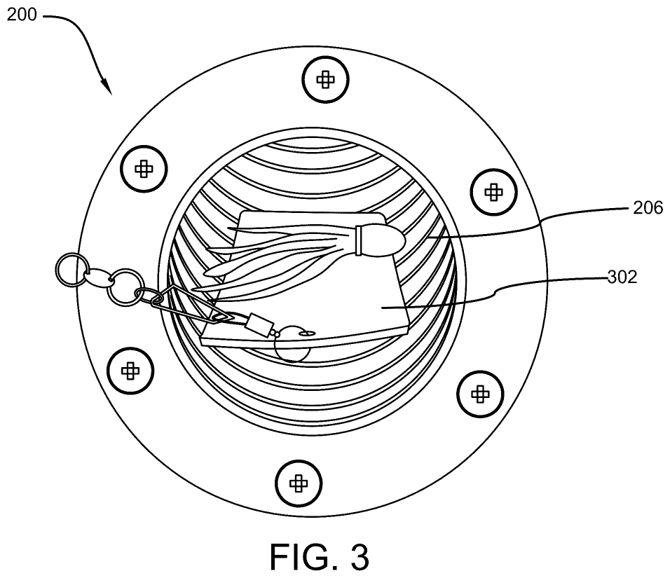

FIG. 3 illustrates a perspective view showing use of the ultraviolet led-based portable fluorescent fishing lure charging device of the present invention for charging fishing lures in accordance with the disclosed structure. The device 200 is shown as an example in the present embodiment and the same functioning is available in the ultraviolet led-based portable fluorescent fishing lure charging device 100. As illustrated, a fluorescent fishing lure 302 is placed inside the tube device 200 and the LEDs 206 are turned on for providing illumination and charging of the fishing lure 302. The fluorescent lure 302 can be placed in the UV radiations for a predetermined time period for recharging and illuminating. When the lure 302 is exposed to UV light, the lure 302 absorbs the light and re-emits the light as visible light, thereby glowing in the dark. The charging makes the lure 302 more attractive to fish in low-light conditions. The fishing lure 302 is charged in 360-degress (i.e., 3D surface area) and eliminates uneven charging of the fishing lure.

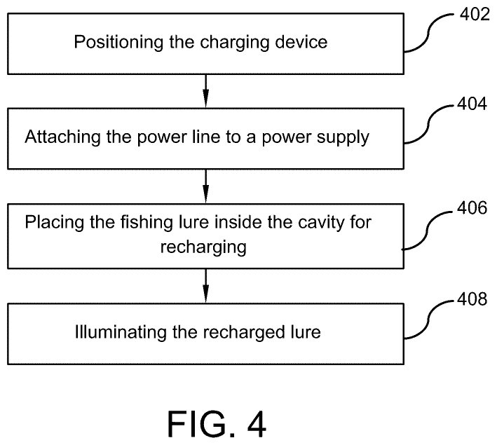

FIG. 4 illustrates a flow chart depicting a process of use of the charging fishing lures using the charging device of the present invention in accordance with the disclosed structure. Initially, the charging device is positioned at an appropriate position on a water vessel such as a boat (Step 402). Then, the power wire 118 is attached to a power supply for supplying electric power to the embedded UV LED lights (Step 404). Thereafter, a fishing lure is placed in the device and the UV LEDs charge the fishing lure for illumination (Step 406). Finally, the recharged fishing lure illuminates without any external light or power supply and can be used for productive and effective fishing (Step 408).

The devices 100, 200 of the present invention enable fluorescent fishing lures to glow brighter and longer without the need for a flashlight or camera flash. The devices 100, 200 are helpful for night fishing or deep-sea fishing where visibility is low. The device works by charging the fluorescent material in the fishing lures with UV light.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable ultraviolet fluorescent fishing lure charging tube device”, “charging device”, “ultraviolet led-based portable fluorescent fishing lure charging device”, and “device” are interchangeable and refer to the ultraviolet LEDs-based portable fluorescent fishing lure charging device 100, 200 of the present invention.

Notwithstanding the forgoing, the ultraviolet LEDs-based portable fluorescent fishing lure charging device 100, 200 of the present invention can be of any suitable size and configuration as is known in the art without affecting the overall concept of the invention, provided that it accomplishes the above stated objectives. One of ordinary skill in the art will appreciate that the ultraviolet LEDs-based portable fluorescent fishing lure charging device 100, 200 as shown in the FIGS. are for illustrative purposes only, and that many other sizes and shapes of the ultraviolet LEDs-based portable fluorescent fishing lure charging device 100, 200 are well within the scope of the present disclosure. Although the dimensions of the ultraviolet LEDs-based portable fluorescent fishing lure charging device 100, 200 are important design parameters for user convenience, the ultraviolet LEDs-based portable fluorescent fishing lure charging device 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ultraviolet fluorescent charging tube for fishing lures comprising:
a hollow cylindrical main body having an interior surface; and
a plurality of waterproof UV LED lights;
wherein said hollow cylindrical main body forming a cavity inside said hollow cylindrical main body;
wherein said interior surface lined with said plurality of waterproof UV LED lights; and
further wherein said plurality of waterproof UV LED lights are UV-A LED lights for charging glow-in-the-dark materials of a glow-in-the dark fishing lure.

2. The ultraviolet fluorescent charging tube for fishing lures of claim 1, wherein said UV-A LED lights are in a wavelength range of 320 nm to 410 nm.

3. The ultraviolet fluorescent charging tube for fishing lures of claim 2, wherein said UV-A LED lights emit a concentrated beam of UV light for charging said glow-in-the-dark fishing lure.

4. The ultraviolet fluorescent charging tube for fishing lures of claim 3, wherein said UV-A LED lights are waterproof including a waterproof rating of at least IP65.

5. The ultraviolet fluorescent charging tube for fishing lures of claim 4, wherein said UV-A LED lights arranged in a sheet light configuration.

6. The ultraviolet fluorescent charging tube for fishing lures of claim 4, wherein said UV-A LED lights arranged in a ribbon style configuration.

7. The ultraviolet fluorescent charging tube for fishing lures of claim 6, wherein said hollow cylindrical main body having an open first end and a selectively closable opposing second end.

8. The ultraviolet fluorescent charging tube for fishing lures of claim 7, wherein said open first end for placing said glow-in-the-dark fishing lure therethrough and into said cavity.

9. The ultraviolet fluorescent charging tube for fishing lures of claim 8 further comprising a power wire routed through said second end for supplying electrical power to said UV-A LED lights.

10. An ultraviolet fluorescent charging tube for fishing lures comprising:
a hollow cylindrical main body having an interior surface;
a plurality of waterproof UV LED lights; and
a gunwale mount;
wherein said hollow cylindrical main body forming a cavity inside said hollow cylindrical main body;
wherein said interior surface lined with said plurality of waterproof UV LED lights; and
further wherein said hollow cylindrical main body connected to said gunwale mount for securing to a boat gunwale.

11. The ultraviolet fluorescent charging tube for fishing lures of claim 10, wherein said plurality of waterproof UV LED lights are UV-A LED lights for charging glow-in-the-dark materials of a glow-in-the-dark fishing lure.

12. The ultraviolet fluorescent charging tube for fishing lures of claim 11, wherein said UV-A LED lights are in a wavelength range of 320 nm to 410 nm.

13. The ultraviolet fluorescent charging tube for fishing lures of claim 11, wherein said UV-A LED lights emit a concentrated beam of UV light for charging said glow-in-the-dark fishing lure.

14. The ultraviolet fluorescent charging tube for fishing lures of claim 11, wherein said UV-A LED lights are waterproof including a waterproof rating of at least IP65.

15. The ultraviolet fluorescent charging tube for fishing lures of claim 10, wherein said hollow cylindrical main body having an open first end and a selectively closable opposing second end.

16. The ultraviolet fluorescent charging tube for fishing lures of claim 15, wherein said open first end for placing said glow-in-the-dark fishing lure therethrough and into said cavity.

17. The ultraviolet fluorescent charging tube for fishing lures of claim 10, further comprising a power wire routed through said second end for supplying electrical power to said plurality of waterproof UV LED lights.

18. The ultraviolet fluorescent charging tube for fishing lures of claim 10, wherein said gunwale mount having a flange for securing around said open first end, and further wherein said hollow cylindrical main body insertable into the boat gunwale and said flange securable to a rim of the boat gunwale.

19. A method of charging a glow-in-the dark fishing lure, the method comprising the steps of:
providing a hollow cylindrical main body having an interior surface, a plurality of waterproof UV LED lights, and a gunwale mount, wherein said hollow cylindrical main body forming a cavity inside said hollow cylindrical main body, wherein said interior surface lined with said plurality of waterproof UV LED lights, further wherein said hollow cylindrical main body having an open first end;
connecting said gunwale mount to said hollow cylindrical main body;
securing said gunwale mount to a boat gunwale;
placing a glow-in-the-dark fishing lure through said open first end and into said cavity;
exposing said glow-in-the-dark fishing lure to said plurality of waterproof UV LED lights; and
charging glow-in-the-dark materials of said glow-in-the-dark fishing lure.

20. The method of charging a glow-in-the dark fishing lure of claim 19, wherein said gunwale mount having a flange for securing around said open first end, and further wherein said hollow cylindrical main body insertable into the boat gunwale and said flange securable to a rim of the boat gunwale.
